(19) United States
(12) Patent Application Publication
(10) Pub. No.: US 2013/0106030 A1
(43) Pub. Date: May 2, 2013

(54) METHOD OF MANUFACTURING CERAMIC ELECTRONIC COMPONENT

(71) Applicants: Byung Kwon YOON, Suwon (KR); Chul Seung Lee, Seoul (KR); Su Yeoun Kim, Suwon (KR)

(72) Inventors: Byung Kwon YOON, Suwon (KR); Chul Seung Lee, Seoul (KR); Su Yeoun Kim, Suwon (KR)

(73) Assignee: SAMSUNG ELECTRO-MECHANICS CO., LTD.

(21) Appl. No.: 13/431,731

(22) Filed: Mar. 27, 2012

(30) Foreign Application Priority Data
Oct. 26, 2011 (KR) 10-2011-0109701

(51) Int. Cl. C04B 35/64

(52) U.S. Cl. 264/610

(57) ABSTRACT

There is provided a method of manufacturing ceramic electronic components having excellent reliability. According to the present invention, pre-burning out is additionally performed prior to burning out. According to the present invention, the occurrence of cracks can be prevented and the ceramic electronic components having excellent reliability can be obtained.

### CROSS-REFERENCE TO RELATED APPLICATIONS

This application claims the priority of Korean Patent Application No. 2011-0109701 filed on Oct. 26, 2011 in the Korean Intellectual Property Office, the disclosure of which is incorporated herein by reference.

### BACKGROUND OF THE INVENTION

1. Field of the Invention

The present invention relates to a method of manufacturing ceramic electronic components. More particularly, the present invention relates to a method of manufacturing ceramic electronic components having excellent reliability.

2. Description of the Related Art

Ceramic electronic components are manufactured by burning out and sintering ceramic green chips.

Gas may be generated due to the simultaneous decomposition of a plasticizer, a binder, or the like, during the burning out process of the ceramic green chip.

Pressure in the ceramic green chip may be increased due to a narrow path through which gas may be discharged therefrom, which may result in the occurrence of cracks therein. In addition, in the case of delamination in the ceramic green chip, the size of the ceramic green chip may be increased, which may degrade product reliability.

In order to solve the above defects, a method of performing burning-out as slowly as possible or for controlling a reaction speed by controlling the atmosphere in which the burning out process takes place so as to generate gas as slowly and in as small an amount as possible have been provided.

However, the methods detailed above have limitations in terms of implementation costs or of an actual effect thereof, according to differentiation of a dielectric substance and an internal electrode and ultrahigh multilayering and ultrahigh thinning of the ceramic green sheet.

### SUMMARY OF THE INVENTION

An object of the present invention provides a method of manufacturing ceramic electronic components having excellent reliability.

According to an aspect of the present invention, there is provided a method of manufacturing ceramic electronic components, including: preparing a ceramic green body; and burning out performed to remove organic components within the ceramic green body, the method further including pre-burning out performed at a temperature lower than a temperature at which the burning out will be performed, before the burning out.

The organic component may be a plasticizer or a binder.

The binder may be polyvinyl butyral.

The plasticizer may be di-octyl-phthalate.

The pre-burning out may be performed within a temperature range including a decomposition temperature of the plasticizer.

The pre-burning out may be performed at 180° C. or less.

The pre-burning out may be performed at 90 to 120° C.

The pre-burning out may be performed at a pressure of 5×10⁻³ torr or less.

The pre-burning out may be performed at 90 to 120° C. and at a pressure of 5×10⁻³ torr or less.

A weight reduction of the ceramic green body may be within an added plasticizer wt %±0.6 wt % after the pre-burning out.

The ceramic may include a dielectric material or a magnetic material.

The dielectric material may include barium titanate.

The magnetic material may include nickel-zinc-copper ferrite.

According to another aspect of the present invention, there is provided a method of manufacturing ceramic electronic components, including: preparing a ceramic green laminate on which a conductive pattern and a ceramic green sheet are alternately stacked; and burning out performed to remove organic components of the ceramic green laminate, the method further including pre-burning out performed at a temperature lower than temperature at which burning out will be performed prior to the burning out.

The organic component may be a plasticizer or a binder.

The binder may be polyvinyl butyral.

The plasticizer may be di-octyl-phthalate.

The pre-burning out may be performed within a temperature range including a decomposition temperature of the plasticizer.

The pre-burning out may be performed at 180° C. or less.

The pre-burning out may be performed at 90 to 120° C.

The pre-burning out may be performed at a pressure of 5×10⁻³ torr or less.

The pre-burning out may be performed at 90 to 120° C. and at a pressure of 5×10⁻³ torr or less.

A weight reduction of the ceramic green laminate may be within an added plasticizer wt %±0.6 wt % after the pre-burning out.

The ceramic may include a dielectric material or a magnetic material.

The dielectric material may include barium titanate.

The magnetic material may include nickel-zinc-copper ferrite.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flow chart of a method of manufacturing ceramic electronic components according to an embodiment of the present invention;

FIG. 2A is an appearance perspective view of ceramic electronic components manufactured according to a method of manufacturing ceramic electronic components according to another embodiment of the present invention;

FIG. 2B is a cross-sectional view taken along line X-X′ of FIG. 2A; and

FIGS. 3A through 3C are views showing an internal structure of the “Y” portion of FIG. 2B prior to pre-burning out, after pre-burning out, and after burning out, respectively.

### DETAILED DESCRIPTION OF THE INVENTION

Embodiments of the present invention will now be described in detail with reference to the accompanying drawings.

The embodiments of the present invention may be modified in many different forms and the scope of the invention should not be limited to the embodiments set forth herein.

Rather, these embodiments are provided so that this disclosure will be thorough and complete, and will fully convey the concept of the invention to those skilled in the art.

In the drawings, the shapes and dimensions may be exaggerated for clarity, and the same reference numerals will be used throughout to designate the same or like components.

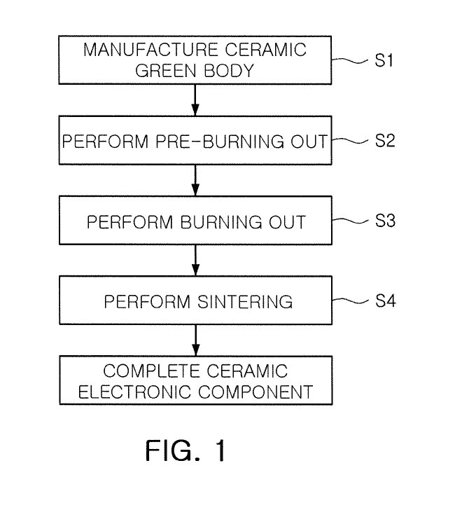

FIG. 1 is a schematic flow chart of a method of manufacturing ceramic electronic components according to an embodiment of the present invention.

The method of manufacturing ceramic electronic components according to the embodiment of the present invention may include preparing a ceramic green body (S1); and burning out performed to remove organic component within the ceramic green body (S3), and may further include pre-burning out performed at a temperature lower than temperature at which burning out will be performed before the burning out (S2).

Referring to FIG. 1, the ceramic electronic components may be manufactured by performing the preparing of the ceramic green body (S1), the pre-burning out (S2), the burning out (S3), and sintering (S4).

The ceramic electronic components are referred to as electronic components formed of ceramic materials and may be manufactured by sintering the ceramic green body. The ceramic green body may be manufactured to have a specific shape by mixing a ceramic power with a binder dispersant, or the like, and putting the mixture in a frame (S1). The organic components such as the binder, the dispersant, or the like, may still be present in the inside of the ceramic green body.

The organic components are not particularly limited, but may include a plasticizer or a binder. In addition, the organic components may also include a residual solvent, a dispersant, or the like.

The binder is not particularly limited, but may be polyvinyl butyral (PVB).

The plasticizer is not limited, but may di-octyl-phthalate (DOP).

Next, the pre-burning out (S2) may be performed.

The pre-burning out may be performed at the temperature lower than the temperature at which burning out will be performed before the burning out and in reduced pressure.

The pre-burning out may refer to forming paths while discharging the organic components such as the plasticizer, the residual solvent, a portion of the binder, or the like, which exist in a relatively small quantity within the ceramic green body and are decomposed at a relatively low temperature, to the outside of the ceramic green body by heating the ceramic green body at a temperature lower than the temperature of the burning out prior to the burning-out.

That is, the pre-burning out may refer to generating a small quantity of decomposed gas such as the residual solvent, the plasticizer, or the like by heating the organic components such as the binder, or the like, which are simultaneously decomposed, at the temperature lower than the temperature of the burning out, such that the fine paths are formed in the ceramic green body while discharging the small quantity of gas to the outside of the ceramic green body.

When the burning out is directly performed without the pre-burning out, the gas pressure in the ceramic green body may be sharply increased due to the gas generated due to the simultaneous decomposition of the organic components such as the binder, or the like, which exist in the ceramic green body, resulting in the occurrence of cracks.

The pre-burning out may be performed prior to entering the burning out to form the fine paths in the ceramic green body. Thereafter, even in the case that the organic components such as the binder, or the like, at the burning out are decomposed, the gas may be discharged to the outside of the ceramic green body through the paths, which may suppress the sharp increase in gas pressure in the ceramic green body. Therefore, the occurrence of cracks can be prevented.

In addition, the pre-burning out may be performed to reduce the amount of residual carbon within the ceramic body, thereby improving the reliability of electronic component chips.

The pre-burning out may be performed within the temperature range in which the plasticizer is decomposed.

The temperature in which the pre-burning out is performed is the temperature in which the plasticizer is decomposed.

The pre-burning out mainly removes the plasticizer by volatilization. During the pre-burning out, the fine paths may be formed in the ceramic green body.

However, the pre-burning out is not limited thereto and the residual solvent, a portion of the binder, or the like, may be removed at the pre-burning out.

The pre-burning out may be performed at a temperature of 180° C. or less.

Although the pre-burning out temperature may be slightly changed according to plasticizer, the pre-burning out may be performed at a temperature lower than the temperature at which the binder starts to be decomposed.

When the temperature performing the pre-burning out is higher than 180° C., the binder may start be decomposed, such that the effect of performing the pre-burning out can be remarkably reduced.

In detail, when the di-octyl-phthalate is used as the plasticizer, the pre-burning out may be performed at 90 to 120° C.

The small quantity of di-octyl-phthalate may be decomposed within the temperature range. At this time, the fine paths may be formed while the generated gas is discharged to the outside.

In addition, when polyvinyl butyral is used as the binder, the polyvinyl butyral starts to be decomposed at 180° C. or more, and thus, the pre-burning out may be performed at 180° C. or less.

The pre-burning out may be performed at a pressure of 5×10⁻³ torr or less.

When the pressure performing the pre-burning out is larger than 5×10⁻³ torr, the gas path may not be appropriately formed within the ceramic green body, which may result in the occurrence of delamination or cracks during the burning out, or the like. Therefore, the effect of the pre-burning out may be remarkably degraded.

In addition, the pre-burning out may be performed at the temperature of 180° C. or less and at the pressure of 5×10⁻³ torr or less.

The description of the temperature and the pressure is the same as one described above.

After the pre-burning out, a weight reduction of the ceramic green body may be within the added plasticizer wt %±□0.6 wt %.

The occurrence of cracks may be prevented by appropriately controlling time so that the weight reduction of the ceramic green body is within the added plasticizer wt % □±0.6 wt %.

That is, when most of the plasticizer is decomposed and removed, the occurrence of cracks may be suppressed ideally. The reason is that a relatively large number of fine paths formed while discharging the decomposed gas of the plasticizer may be distributed in the ceramic green body.

After the pre-burning out, when the weight reduction of the ceramic green body is smaller than the added plasticizer wt %-0.6 wt %, a considerable amount of the plasticizer remains in the ceramic green body even after the pre-burning out is performed. Therefore, the internal pressure may be sharply increased due to the gas generated due to the decomposition of the plasticizer during the burning out, thereby causing the occurrence of cracks.

After the pre-burning out, when the weight reduction of the ceramic green body is greater than 0.6 wt % of the added plasticizer wt %, delamination may occur after the pre-burning out and continue to remain even after the burning out is performed, thereby causing the occurrence of cracks.

Next, the burning out (S3) may be performed.

The burning out may be referred to a process of removing organic components that exist within the ceramic green body.

The organic components such as the binder, the plasticizer, the solvent, or the like, that exist within the ceramic green sheet may be removed by the burning out process, such that the organic components may not affect the characteristics of the final electronic component chips.

Since gas is generated due to the simultaneous decomposition of the binder, or the like, during the burning out process, the gas pressure in the ceramic green body may be sharply increased. The path through which the gas is discharged to the outside may be formed in advance by performing the pre-burning out as described above, thereby preventing the pressure in the ceramic green body from being sharply increased. Therefore, the occurrence of cracks may be prevented.

Next, the sintering (S4) may be performed.

Densification may be formed by moving atoms existing on a surface of a ceramic powder particle or a metal power particle at high temperature. Thereafter, the sintering may be performed by a process of aggregating grains and growing the grains.

The fine paths formed at the pre-burning out may disappear by the densification, the grain aggregation, or the like, while being subjected to the sintering process. Therefore, the fine paths in the electronic components, or the like, may not be observed after the sintering.

After performing the post-processing process such as polishing the surface of the ceramic chip subjected to the sintering process, an external electrode may be formed.

The external electrode may be formed of conductive metals such as copper, or the like, and paste including glass frit, but is not limited thereto. An example of the conductive metal may include copper, a copper alloy, nickel, a nickel alloy, silver, palladium, or the like. In addition, a nickel/tin plating layer may be formed on the external electrode so as to facilitate the mounting.

The ceramic may include a dielectric material or a magnetic material. An example of the dielectric material may include barium titanate and an example of the magnetic material may include nickel-zinc-copper ferrite.

When the ceramic is a dielectric material including barium titanate, or the like, an electronic component may be a capacitor, and when the ceramic is a magnetic material including the nickel-zinc-copper ferrite, or the like, an electronic component may be an inductor.

Hereinafter, a method of manufacturing ceramic electronic components according to another embodiment of the present invention will be described below. That is, a method of manufacturing multilayer ceramic electronic components will be described below.

An example of the multilayered electronic components may include a multilayer ceramic capacitor, a chip inductor, a chip bead, a chip varistor, or the like.

Recently, with the miniaturization and lightness of electronic products, a demand for the small and high-capacity electronic components has been increased. To meet the tendency, a demand for multilayered electronic components has also been increased.

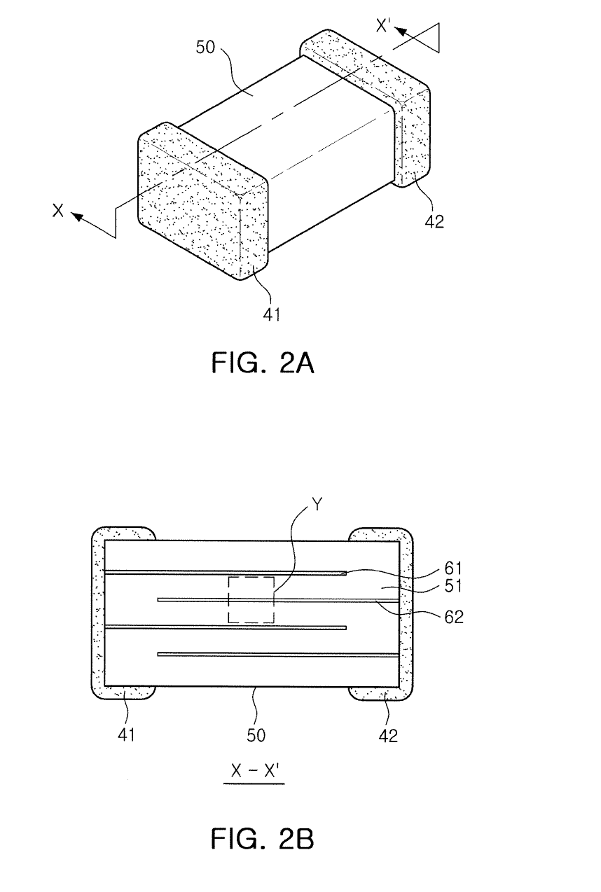

FIG. 2A is a perspective view showing an appearance of ceramic electronic components manufactured according to the embodiment of the present invention and FIG. 2B is a cross-sectional view taken along line X-X′ of FIG. 2A.

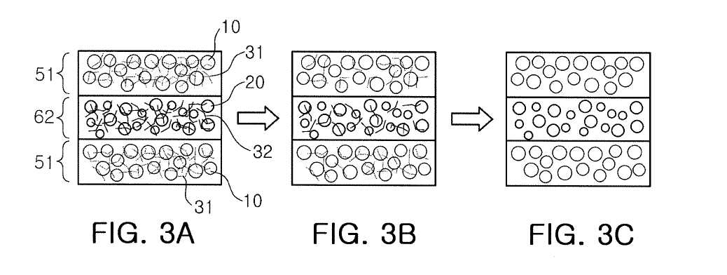

FIGS. 3A through 3C are views showing an internal structure of the “Y” portion before pre-burning out, after pre-burning out, and after burning out, respectively.

Referring to FIGS. 2 and 3, the method of manufacturing ceramic electronic components according to another embodiment of the present invention may include: preparing a ceramic green laminate on which a conductive pattern and a ceramic green sheet are alternately stacked; and burning out performed to remove organic components of the ceramic green laminate, and may further include pre-burning out performed at a temperature lower than temperature at which burning out will be performed, prior to the burning out.

The ceramic green laminate may be manufactured by the following method.

First, ceramic slurry may be prepared by mixing a ceramic power 10 with organic components 31 and 32 such as an organic solvent, a plasticizer, a binder, or the like, and uniformly distributing the ceramic powder by methods such as ball mill, or the like.

When the ceramic powder 10 is a high dielectric material using barium titanate or the like as a main material, an electronic component may be a capacitor, and when the ceramic powder 10 is a magnetic material such as ferrite, or the like, an electronic component may be an inductor.

As the ceramic powder 10, a barium titanate (BaTiO₃) based material, a strontium titanate (SrTiO₃) based material, or the like, may be used, but is not limited thereto.

Next, ceramic green sheets 51 may be prepared by thinly applying the ceramic slurry on a polymer film such as polyethylene, or the like, by methods such as doctor blade, or the like, and drying the applied ceramic slurry.

Next, conductive paste may be prepared by mixing conductive metals 20 such as gold, silver, copper, nickel, palladium, or the like, with organic components 31, 32 such as an organic solvent, a plasticizer, a binder, or the like, and uniformly dispersing the conductive metals by the methods such as the ball mill, or the like.

The organic solvent is not particularly limited but may be, for example, terpineol, dihydroterpineol, butylcarbitol, kerosene, or the like.

As the binder, polymer resins such as polyvinyl butyral, ethylcellulose, or the like, may be used.

Next, the ceramic green laminate may be manufactured by forming the conductive patterns 61 and 62 by printing the conductive paste on the ceramic green sheet using screen printing, or the like, and stacking the ceramic green sheets 51 on which the conductive patterns 61 and 62 were printed by a desired thickness.

Referring to FIG. 3B, the organic components 31 and 32 such as the binder, or the like, may still remain in the ceramic green sheets 51 and the conductive pattern 62 of the ceramic green laminate.

The organic components 31 and 32 may be plasticizer or dispersant. In this case, the binder may be polyvinyl butyral and the plasticizer may be di-octyl-phthalate.

The pre-burning out may be performed within the temperature range including the decomposition temperature of plasticizer.

The pre-burning out may be performed at 180□° C. or less.

The pre-burning out may be performed at a pressure of 5×10⁻³ torr or less.

After the pre-burning out, the weight reduction of the ceramic green laminate may be within ±5% of the content of the plasticizer.

Referring to FIG. 3B, fine paths may be formed within the ceramic green laminate by reducing the organic components 31 and 32 such as plasticizer or the like by removing a portion thereof and thus discharging the organic components 31 and 32 such as the plasticizer or the like, corresponding to the reduced amount, to the outside of the ceramic green laminate.

Thereafter, the organic components 31 and 32 such as the binder or the like may be completely decomposed by the burning out and therefore, the generated gas may be discharged to the outside of the ceramic green laminate through the fine paths formed in advance at the pre-burning out.

As a result, pressure in the ceramic green laminate may not be sharply increased and the occurrence of cracks may be suppressed in the ceramic green laminate.

Thereafter, the fine paths formed at the pre-burning out may disappear by densification, grain aggregation, or the like, while being subjected to the sintering process. Therefore, the fine paths in the electronic components, or the like, may not be observed after the sintering.

The ceramic may include a dielectric material or a magnetic material.

As the dielectric material, barium titanate may be used, and as the magnetic material, nickel-zinc-copper ferrite may be used.

Description of the organic component, the pre-burning out, the ceramic, or the like, are the same as described above.

### Example

In order to confirm whether the cracks occur during the burning out process while changing the pre-burning out temperature, the multilayer ceramic capacitor was manufactured as follows.

The ceramic slurry was manufactured by mixing barium titanate as the ceramic powder, ethanol as the organic solvent, di-octyl-phthalate as the plasticizer, and polyvinyl butyral as the binder and uniformly distributing the mixture by the ball mill, and the ceramic green sheet was prepared by applying the ceramic slurry by the doctor blade method.

1.53 wt % of the di-octyl-phthalate as the plasticizer and 8.86 wt % of the polyvinyl butyral as a binder were added.

The conductive pattern was formed by printing the conductive paste on the ceramic green sheet. The conductive paste including nickel metal and ethylcellulose was used.

The ceramic laminate was manufactured by stacking the ceramic green sheets on which the conductive patterns are formed, up to 200 layers.

The ceramic laminate was subjected to iso-static pressing at a pressure of 500 kgf/cm² at 85° C.

The ceramic laminate subjected to the pressing was cut in a form of an individual chip and the cut chip was subjected to the pre-burning out process.

The pre-burning out was performed under the following conditions.

That is, whether the cracks occur was observed according to the change in the burning out temperature by maintaining the pressure in the vacuum chamber to be 10⁻⁴ torr and changing the temperature in the vacuum chamber to 60° C., 80° C., 100° C., 120° C., and 140° C. and the pre-burning out was performed for 1 hour.

Thereafter, the burning out process was performed while being maintained at 230° C. for 100 hours in the air.

Thereafter, the sintering was performed in the reduction atmosphere under the oxygen partial pressure of 10⁻¹¹ atm to 10⁻¹⁰ atm lower than Ni/NiO equilibrium oxygen partial pressure so that the internal electrode is not oxidized at 1200° C.

An average thickness of an electrode layer was 0.65 μm after the sintering.

A size of the firing chip was (1.0 mm)×(0.5 mm)×(0.5 mm).

Whether the cracks occur after performing the sintering process on the prepared multilayer ceramic capacitor was observed and the observed results were shown in Table 1.

TABLE 1

| | | Weight variations | | |
|---|---|---|---|---|
| | | of ceramic | Delami- | |
| | Pre-burning out | green laminate | nation | Crack |
| | temperature | after pre-burning | occurrence | occurrence |
| Division | (° C.) | out (wt %) | rate (%) | rate (%) |
| Comparative | 60 | −0.79 | 0 | 10 |
| Example 1 | | | | |
| Inventive | 80 | −1.16 | 0 | 0 |
| Example 1 | | | | |
| Inventive | 100 | −1.53 | 0 | 0 |
| Example 2 | | | | |
| Inventive | 120 | −2.07 | 0 | 0 |
| Example 3 | | | | |
| Comparative | 140 | −2.65 | 2 | 3 |
| Example 2 | | | | |

Comparative Example 1 corresponds to the case in which the pre-burning out temperature is 60° C. In this case, the weight reduction of the ceramic green laminate was 0.79 wt % after the pre-burning out. The amount smaller than the content (1.53 wt %) of the added plasticizer was removed by the pre-burning out and 0.74 wt % of the plasticizer remained in the ceramic green laminate. This may be derived due to the low temperature and the small amount of decomposed plasticizer.

Thereafter, the delamination did not occur during the burning out process but 10% of cracks occurred. The reason why the cracks occur is that the pressure in the ceramic green laminate is sharply increased due to the simultaneous pyrolysis of residual plasticizer.

Inventive Examples 1, 2, and 3 correspond to the case in which the pre-burning out temperature is 80° C., 100° C., and 120° C. In this case, the weight reduction of the ceramic green laminate after the pre-burning out is 1.16 wt %, 1.53 wt %, and 2.07 wt %, respectively.

In Inventive Example 1, the amount smaller than the content (1.53 wt %) of the added plasticizer was removed by the pre-burning out and 0.37 wt % of the plasticizer remained in the ceramic green laminate.

In Inventive Example 2, the amount corresponding to the content (1.53 wt %) of the added plasticizer was removed by the pre-burning out. Therefore, it can be derived that the plasticizer was completely removed.

In Inventive Example 3, the amount greater than the content (1.53 wt %) of the added plasticizer was removed, which may be derived that a portion of the binder is removed by being more decomposed due to the relatively high temperature.

Thereafter, the delamination and the cracks did not occur during the burning out process in the cases of Inventive Examples 1, 2, and 3.

Comparative Example 2 corresponds to the case in which the pre-burning out temperature is 140° C. In this case, the weight reduction of the ceramic green laminate was 2.65 wt % after the pre-burning out. The amount greater than the content (1.53 wt %) of the added plasticizer was removed. This may be derived that a portion of the binder is removed by being more decomposed due to the high temperature.

Thereafter, 2% of the delamination and 3% of the cracks occurred during the burning out process, which may maintain the path through which the plasticizer and the binder are discharged as it is and act as the occurrence factors of the delamination and the cracks.

As set forth above, according to the embodiments of the present invention, the ceramic electronic components with the excellent reliability without the occurrence of cracks even after the burning out process may be obtained.

While the present invention has been shown and described in connection with the embodiments, it will be apparent to those skilled in the art that modifications and variations can be made without departing from the spirit and scope of the invention as defined by the appended claims.

What is claimed is:

1. A method of manufacturing ceramic electronic components, comprising:
preparing a ceramic green body; and
burning out performed to remove organic components within the ceramic green body,
the method further comprising:
pre-burning out performed at a temperature lower than a temperature at which the burning out will be performed, before the burning out.

2. The method of claim 1, wherein the organic component is a plasticizer or a binder.

3. The method of claim 2, wherein the binder is polyvinyl butyral.

4. The method of claim 2, wherein the plasticizer is di-octyl-phthalate.

5. The method of claim 1, wherein the pre-burning out is performed within a temperature range including a decomposition temperature of the plasticizer.

6. The method of claim 1, wherein the pre-burning out is performed at 180° C. or less.

7. The method of claim 1, wherein the pre-burning out is performed at 90 to 120° C.

8. The method of claim 1, wherein the pre-burning out is performed at a pressure of 5×10⁻³ torr or less.

9. The method of claim 1, wherein the pre-burning out is performed at 90 to 120° C. and a pressure of 5×10⁻³ torr or less.

10. The method of claim 1, wherein a weight reduction of the ceramic green body is within an added plasticizer wt %±0.6 wt % after the pre-burning out.

11. The method of claim 1, wherein the ceramic includes a dielectric material or a magnetic material.

12. The method of claim 11, wherein the dielectric material includes barium titanate.

13. The method of claim 11, wherein the magnetic material includes nickel-zinc-copper ferrite.

14. A method of manufacturing ceramic electronic components, comprising:
preparing a ceramic green laminate on which a conductive pattern and a ceramic green sheet are alternately stacked; and
burning out performed to remove organic components of the ceramic green laminate,
the method further comprising:
pre-burning out performed at a temperature lower than a temperature at which the burning out will be performed, prior to the burning out.

15. The method of claim 14, wherein the organic component is a plasticizer or a binder.

16. The method of claim 14, wherein the binder is polyvinyl butyral.

17. The method of claim 14, wherein the plasticizer is di-octyl-phthalate.

18. The method of claim 14, wherein the pre-burning out is performed within a temperature range including a decomposition temperature of the plasticizer.

19. The method of claim 14, wherein the pre-burning out is performed at 180° C. or less.

20. The method of claim 14, wherein the pre-burning out is performed at 90 to 120□° C.

21. The method of claim 14, wherein the pre-burning out is performed at a pressure of 5×10⁻³ torr or less.

22. The method of claim 14, wherein the pre-burning out is performed at 90 to 120° C., and a pressure of 5×10⁻³ torr or less.

23. The method of claim 14, wherein a weight reduction of the ceramic green laminate is within an added plasticizer wt %±0.6 wt % after the pre-burning out.

24. The method of claim 14, wherein the ceramic includes a dielectric material or a magnetic material.

25. The method of claim 24, wherein the dielectric material includes barium titanate.

26. The method of claim 24, wherein the magnetic material includes nickel-zinc-copper ferrite.
